(19) United States
(12) Patent Application Publication
(10) Pub. No.: US 2022/0303278 A1
(43) Pub. Date: Sep. 22, 2022

(54) CAPTIVE PORTAL FOR TIERED ACCESS USING CONDITIONAL DNS FORWARDING

(71) Applicant: Hughes Systique Corporation, Gurgaon (IN)

(72) Inventors: Pradeep KIRNAPURE, Gurgaon (IN); Amol PATHAK, Gurgaon (IN)

(21) Appl. No.: 17/655,185

(22) Filed: Mar. 17, 2022

(30) Foreign Application Priority Data
Mar. 18, 2021 (IN) 202111011617

(51) Int. Cl. H04L 9/40; H04L 61/2503

(52) U.S. Cl. CPC H04L 63/104; H04L 63/0263; H04L 63/08; H04L 61/2503

(57) ABSTRACT

A system for conditional forwarding to Domain Name Server (DNS) instance in a captive portal (CP) for tiered access of internet services is disclosed here comprising a firewall, a host server, and an application server. The host server is in communication with the firewall comprising DNS instances that assist in name resolution as per the tiered access. The application server is in communication with the firewall comprising the CP and a captive network controller (CNC). The CNC controls the access group policies to determine whether to associate a user device with a selected access group policy. The forwarding module of firewall is in communication with the D-NAT module of firewall to forward DNS queries to DNS instances. The DNS queries are mapped against the DNS instances to determine whether the user device needs to be provided with the access of the internet services based on one or more conditions.

### FIELD OF THE INVENTION

The present invention is related to captive portal for tiered access in web access using conditional Domain Name Server (DNS) forwarding. More specifically, providing conditional routing in the local network along with the multi-tier DNS approach, a solution is generated that provides better control to the network service provider in offering internet services in tiered manner.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

In the current art of perennial network connectivity systems, the enterprise applications, user devices and virtually all the machines are thriving on data availability through live data connection. Whether the internet access is free or paid, users prefer continuous connectivity on their devices. While most of the network providers are trying to manage with the pressure on the services, both on availability and quality, a big task that remains is the monetization of these services. Consider a use case in hospitality industry, such as, internet connectivity at remote locations (away from mainland), the operational costs could be a challenge as the backhaul ISP network is expensive. In order to control this access, some service providers choose to give static passwords to all the users, for example, in a small-town café or a small hotel while some larger network installations use captive portal-based user sign-up or integration with social media logins or mobile number-based login mechanisms.

Captive portal is one popularly used mechanism that enables users to authenticate themselves before getting the internet access. Users can provide pre-registered information or voucher codes for authentication. While most of the network service providers allow unrestricted internet access for authenticated users and no internet access for unauthenticated users, some providers may selectively allow restricted internet access to a list of white-listed websites (for e.g. brand promotion sites, local new/information sites, etc.).

In a typical scenario, a new user checks into a hotel facility, and tries to connect a smart phone to the available Wi-Fi network. As a part of standard Dynamic Host Configuration Protocol (DHCP) procedures, the user device is assigned an IP address and provided local DNS server address. After IP assignment, the user device starts the captivity detection process, where in the user device tries to send HTTP request messages to known connectivity check sites and expects a specific response. Instead of specific response, if the device receives a HTTP response that indicates redirection to some web portal, the device opens the captive portal pop-up screen (in an OS specific web-view/embedded-browser), using which each user can proceed with authentication (or sign-up) procedure.

The general solution for DNS based redirection is illustrated in the FIG. 1. In this method, the DNS server resolves the connectivity check URLs to dummy HTTP server IP address and HTTP traffic towards those URLs is then routed to the dummy HTTP server. The dummy HTTP server responds with the redirection (HTTP 302 response code) indication along with the location URL of Web-Authentication server. This simple approach has limitations when used for dynamic internet access provisioning. The standard DNS implementation resolves the destination Fully qualified domain name (FQDN) to an IP address (or IP addresses in round robin manner) based on configured rules. This resolution is static in nature and cannot be done dynamically based of configurable policies. Some customization is required in the DNS to allow dynamic provisioning of resolution policies and enforcement of same on per device basis. However, that puts extra processing load on the DNS.

In view of the above, there is a need to provide a solution that has better control to the network service provider in offering internet services in tiered manner.

### SUMMARY OF THE INVENTION

It is intended that all such features, and advantages be included within this description, be within the scope of the present invention, and be protected by the accompanying claims. The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

A system for conditional forwarding to Domain Name Server (DNS) instance in a captive portal for tiered access of internet services is disclosed herein to address the need for a solution that has better control to the network service provider in offering internet services in tiered manner. The system comprising a firewall, a host server, and an application server. The firewall comprises an access policy module, a forwarding module, and a Destination Network Address Translation (D-NAT) module. The host server is in communication with the firewall comprising DNS instances that assist in name resolution as per the tiered access of the internet services. The application server is in communication with the firewall comprising of the captive portal (CP) and a captive network controller (CNC). The CNC controls the access group policies at the firewall to determine whether to associate a user device with a selected access group policy. The access policy module contains data comprising the access group policies associated with one or more user devices. The forwarding module is in communication with the D-NAT module to forward DNS queries to the one of the DNS instances. The DNS queries are mapped against the DNS instances to determine whether the user device needs to be provided with the access of the internet services based on one or more conditions.

In an embodiment, the DNS instance is designated as a resolver for an access group. The forwarding of the DNS queries is based on the access group policies at the firewall, where separate sub-interfaces are used corresponding to each of the DNS instances, and an IP address assigned to the DNS instances are from different logical subnets. The user device is provided with the tiered access of the internet services by associating or disassociating the user device with the access group policy and based on the conditions that include whether the user device is one of unauthenticated, authenticated, and in an active plan.

In an embodiment, in a first condition of the one or more conditions, the user device is connected to an available communication network and the user device initiates Hypertext Transfer Protocol (HTTP) requests towards the pre-defined connectivity check Uniform Resource Locators (URLs). The DNS queries from user device are hence forwarded to the Captive (Default) DNS instance. The Captive (Default) DNS instance resolves a website fully qualified domain name (FQDN) to a Captive Portal (CP) IP address, where connectivity check HTTP requests are routed to the captive portal over an IP transport network. The captive portal responds with redirect indication (HTTP 302 response) and a captive portal URL, and wherein the user opens an embedded browser in the user device in a predefined manner. Then, the user device sends a DNS query for the captive portal FQDN, wherein the captive DNS instance is default, resolves the captive portal FQDN to IP address of the captive portal. The user device is presented with a landing page of the captive portal and the user is limited to interact with the captive portal and no internet access is allowed, as per access policy enforced by the firewall.

In an embodiment, in a second condition of the one or more conditions, the user device is authenticated by providing a login credential at the captive portal login page, where the captive network controller (CNC) associates the user device with a limited-access-group policy at the firewall by using a firewall management API. Then, the user tries to access a free website from a browser, where the associated DNS query reaches the firewall, and the DNS query is forwarded to a limited-access DNS instance. The limited-access DNS instance resolves free website FQDN to correct IP address and HTTP traffic is routed to a correct website and the user device is enabled to interact with free website. When the user opens a browser and tries to access a non-free website, the DNS query reaches the limited-access DNS instance, where the limited-access DNS instance resolves the non-free website FQDN to the captive portal IP address. The user is then redirected to the captive portal and presented with the option to purchase an internet plan.

In an embodiment, in a third condition of the one or more conditions, the user purchases an internet plan by following an appropriate workflow of the captive portal, where the CNC associates the user device with a full-access-group policy at the firewall by using the firewall management API. The user tries to access any web site on the internet from a browser, where a DNS query reaches the firewall, and the DNS query is forwarded to a full-access DNS instance. The full-access DNS instance resolves the website FQDN to correct IP address, where HTTP traffic from the user device is routed to a correct website and user is enabled to interact with the website. When internet plan expires, the user device is disassociated from the full-access-group policy and associated with a limited-access-group policy. The user then opens the browser and tries to access a non-free website, where a DNS query reaches a limited-access DNS instance. The limited-access DNS instance resolves the non-free website FQDN to the Captive Portal IP address, and the user device is redirected to the captive portal and presented with the option to purchase the internet plan.

A method for conditional forwarding to Domain Name Server (DNS) instance in a captive portal for tiered access of internet services, the method comprising, a first step of assisting in name resolution as per the tiered access of the internet services, via one or more DNS instances that are present in a host server in communication with a firewall. A second step of controlling access group policies at the firewall, via a captive network controller (CNC) present in an application server, to determine whether to associate a user device with a selected access group policy. A third step of forwarding DNS queries to the one of the DNS instances, via the forwarding module in communication with the D-NAT module. A fourth step of mapping the DNS queries against the DNS instances to determine whether the user device needs to be provided with the access of the internet services based on one or more conditions.

The method disclosed herein addresses the above-mentioned need for a solution that provides better control to a network service provider in offering internet services in tiered manner. The method involves using the conditional routing in the local network along with the multi-tier DNS, which gives better control to the network service provider in offering internet services in tiered fashion. The solution disclosed here is an implementation of captive network with multiple tiers of access, by using multiple DNS instances (which could be co-hosted) and policy-based forwarding (with Destination Network Address Translation or D-NAT) at the firewall. The solution is used for managing the internet access (via wireless LAN or traditional LAN) for different kinds of users in a typical enterprise network (such as visitors, employees and IT personnel). The access is managed dynamically by the application layer logic instead of offline network layer access control (usually manual process). Further, the solution works with existing network infrastructure components (such as DNS and Firewall) without need of customization.

The method involves the usage of captive network with multiple tiers of access and involves creating access group policies at the firewall, associating/disassociating the user with appropriate access group policy, using application logic, based on state of the device (unauthenticated/authenticated/active plan), and forwarding the DNS query to appropriate DNS instance (based on the state of the device) for “conditional” resolution of the Fully qualified domain name (FQDN).

### BRIEF DESCRIPTION OF DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic view of the prior art system of DNS based captive portal redirection.

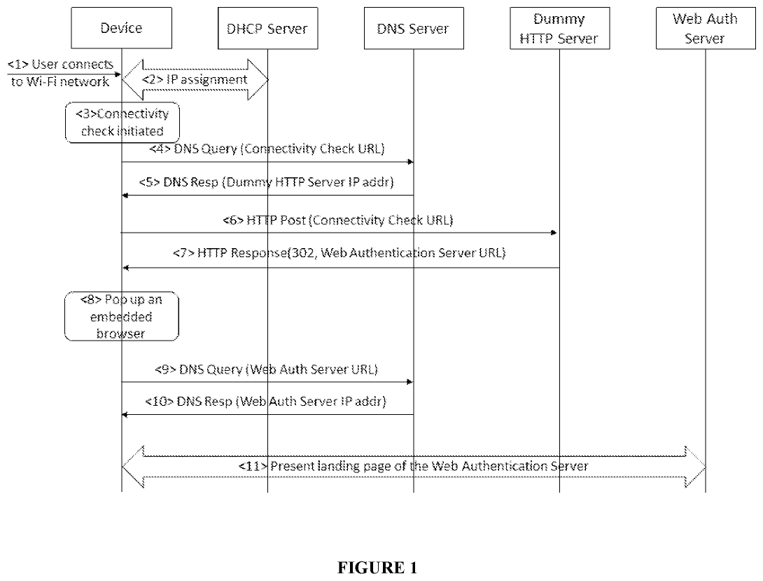

FIG. 2 is a schematic view of the policy-based DNS resolution, as an embodiment of the present disclosure.

FIG. 3 is a schematic view of the workflow for unauthenticated device, as an embodiment of the present disclosure.

FIG. 4 is a schematic view of the workflow for devices in limited-access tier, as an embodiment of the present disclosure.

FIG. 5 is a schematic view of the workflow for devices in full-access tier, as an embodiment of the present disclosure.

FIG. 6 is a schematic view of the method associated with the policy-based DNS resolution, as an embodiment of the present disclosure.

### DESCRIPTION OF THE INVENTION

Exemplary embodiments now will be described. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals used herein illustrate only typical embodiments of the present subject matter, and are therefore, not to be considered for limiting of its scope, for the subject matter may admit to other equally effective embodiments.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the phrase “Unauthenticated user devices” refers to User devices which are not yet authenticated by the captive portal. The phrase “Authenticated user devices” refers to user devices which are already authenticated by the captive portal. The phrase “free website” refers to an internet website which can be accessed by a user device without having an active internet plan. Such an access is allowed by the wi-fi service provider for business promotion. The phrase “Captive (Default) tier” refers to unauthenticated user devices that are assigned to this tier (by default). Such devices are restricted within the Captive Network and have no Internet access. Devices in this tier are associated with Captive (Default) group policy.

Furthermore, as used herein, the phrase “Limited-Access-tier” refers to authenticated user devices that have no active Internet plan assigned to this tier. Such devices are only allowed access to a limited set of free websites. The devices in this tier are associated with Limited-Access group policy. The phrase “Full-Access-tier” refers to authenticated user devices that have active Internet plan assigned to this group. Such devices are allowed full Internet access. The devices in this tier are associated with Full-Access group policy. The phrase “Captive (Default) DNS instance” refers to DNS assigned to Captive (Default) tier for domain name resolution. The phrase “Limited-Access DNS instance” refers to DNS assigned to the Limited-Access tier for domain name resolution. The phrase “Full-Access DNS instance” refers to DNS assigned to Full-Access tier for domain name resolution.

The aim of the present invention is to provide better control to a network service provider in offering internet services in tiered manner. The solution uses multiple DNS instances for captive network realization. The solution supports three tiers of access for the devices. While the solution is applied to any network providing tiered access, this discussion considers the common case of smart phones trying to access internet over public Wi-Fi network. The solution involves the following aspects:

As disclosed, the definition and enforcement of access policies are defined herein. For the purpose of providing different level of net access, the access policies need to be defined/enforced. In an enterprise network, this is typically done at L3 devices like firewall. The following access policy groups are pre-configured using management console (or CLI):

1. Full-Access-Group: devices associated with this group has packet routing/forwarding treatment that enables full internet access.
2. Limited-Access-Group: devices associated with this group has packet routing/forwarding treatment that enables access to limited, white-listed websites.

It should also be noted that the devices that are not associated with the above policy group are provided with the default packet routing/forwarding treatment that forces the device to remain inside the captive network, referred to as Captive (Default)-Group policy. The user devices are associated with these policy groups dynamically by the Captive Network Controller (CNC) using management APIs provided by the firewall. The CNC is aware of the authentication/authorization state of the user device as it controls the different workflows for service provisioning.

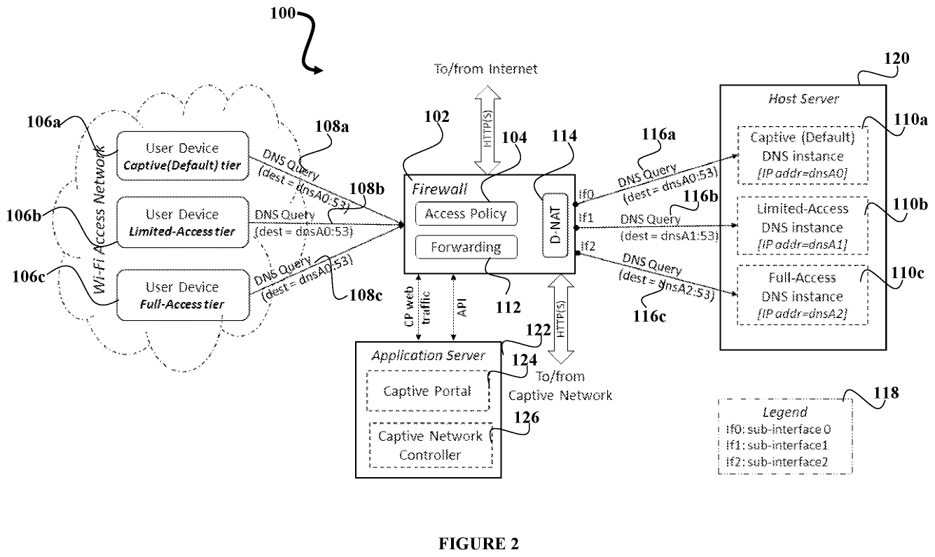

FIG. 2 is a schematic view of the policy-based DNS resolution, as an embodiment of the present disclosure. In other words, FIG. 2 shows a system 100 for conditional forwarding to Domain Name Server (DNS) instance in a captive portal for tiered access of internet services. This solution uses the access policy group in unique way to realize the “conditional” domain name resolution. The firewall 102 uses the access policy associated with a user device 106a, 106b, or 106c to forward DNS queries 108a, 108b, and 108c to a DNS instance 110a, 110b, or 110c that is designated as resolver for that access group. The firewall 102 (or a Networking device available off-the-shelf) comprises access policy module 104, a forwarding module 112, and a Destination Network Address Translation (D-NAT) module 114.

The firewall 102 also applies the D-NAT 114 while forwarding the queries 116a, 116b, or 116c to the selected DNS instance 110a, 110b, or 110c. The below table 1 shows the DNS resolver instance selection 110a, 110b, or 110c and forwarding:

| | | Destination of | | |
|---|---|---|---|---|
| | | DNS Query | Designated DNS | |
| | Associated Access | (IP Addr: | Resolver | |
| No | Policy Group | Port) | instance | Action Required |
| 1 | None (Default-Group | dnsA0:53 | Captive (Default) | No change (Continue using |
| | policy) | | DNS (IP = dnsA0) | default DNS as assigned by |
| | | | | DHCP) |
| 2 | Limited-Access- | dnsA0:53 | Limited-Access | Change destination to dnsA1 |
| | Group policy | | DNS (IP = dnsA1) | using D-NAT and forward to |
| | | | | dnsA1 |
| 3 | Full-Access-Group | dnsA0:53 | Full-Access DNS | Change destination to dnsA2 |
| | policy | | (IP = dnsA2) | using D-NAT and forward to |
| | | | | dnsA2 |

It should also be noted that, in order to do the forwarding based on policy groups at the firewall 102, separate sub-interfaces 118 (virtual interfaces) are used corresponding to each of the DNS instances 110a, 110b, or 110c. The IP addresses assigned to the DNSs 110a, 110b, or 110c are from different logical subnets.

Furthermore, a host server 120 in communication with the firewall 102, and the host server 120 comprises the one or more DNS instances 110a, 110b, or 110c that assist in name resolution as per the tiered access of the internet services. An application server 122 is in communication with the firewall 102 and the application server 122 comprises of a captive portal (CP) 124 and a captive network controller (CNC) 126. The CNC 126 controls the access group policies at the firewall 102 to determine whether to associate a user device 106a, 106b, or 106c with a selected access group policy. The access policy module 104 contains data comprising the access group policies associated with one or more user devices 106a, 106b, or 106c. The forwarding module 112 in communication with the D-NAT module 114 forwards DNS queries 116a, 116b, or 116c to the one of the DNS instances 110a, 110b, or 110c, where the DNS queries 116a, 116b, or 116c are mapped against the DNS instances 110a, 110b, or 110c, to determine whether the user device 106a, 106b, or 106c needs to be provided with the access of the internet services based on one or more conditions.

The DNS instance 110a, 110b, or 110c for each of the access tier is configured with specific rules (A records) for mapping the FQDN to the IP address. Any DNS implementation is used for this purpose. The Table 2 below shows the resolution rules at captive (Default) DNS instance 110a, 110b, or 110c.

| No | Destination FQDN | Resolution policy | Mapped IP address | Comments |
|---|---|---|---|---|
| 1 | example-portal.com | Resolve locally | Captive portal IP | Use local A records |
| | | | address | |
| 2 | Intranet site | Forward to | NA | Use existing DNS as |
| | | resolver | | next hop resolver |
| 3 | * | Resolve locally | Captive portal IP | Force captivity for all |
| | (any other FQDN) | | address | other sites |

The Table 3 below shows the resolution rules at limited-access DNS instance 110a, 110b, or 110c:

| No | Destination FQDN | Resolution policy | Mapped IP address | Comments |
|---|---|---|---|---|
| 1 | example-portal.com | Resolve locally | Captive portal IP | Use local A records |
| | | | address | |
| 2 | Intranet site | Forward to | NA | Use existing DNS as |
| | | resolver | | next hop resolver |
| 3 | Free sites | Forward to | NA | Use existing DNS as |
| | | resolver | | next hop resolver |
| 3 | * | Resolve locally | Captive portal IP | Force captivity for all |
| | (any other FQDN) | | address | other sites |

The Table 4 below shows the resolution rules at full-access DNS instance:

| No | Destination FQDN | Resolution policy | Mapped IP address | Comments |
|---|---|---|---|---|
| 1 | example-portal.com | Resolve locally | Captive portal IP | Use local A records |
| | | | address | |
| 2 | Intranet site URL | Forward to | NA | Use existing DNS as |
| | | resolver | | next hop resolver |
| 2 | Free-site URL | Forward to | NA | Use existing DNS as |
| | | resolver | | next hop resolver |
| 3 | * | Forward to | NA | Use existing DNS as |
| | (any other FQDN) | resolver | | next hop resolver |

As described herein, the user device 106a, 106b, or 106c is provided with the tiered access of the internet services by associating or disassociating the user device 106a, 106b, or 106c with the access group policy (namely Captive(Default)-Group policy or Limited-Access-Group policy or Full-Access-Group policy) and based on the conditions that include whether the user device 106a, 106b, or 106c is one of unauthenticated, authenticated, and in an active plan.

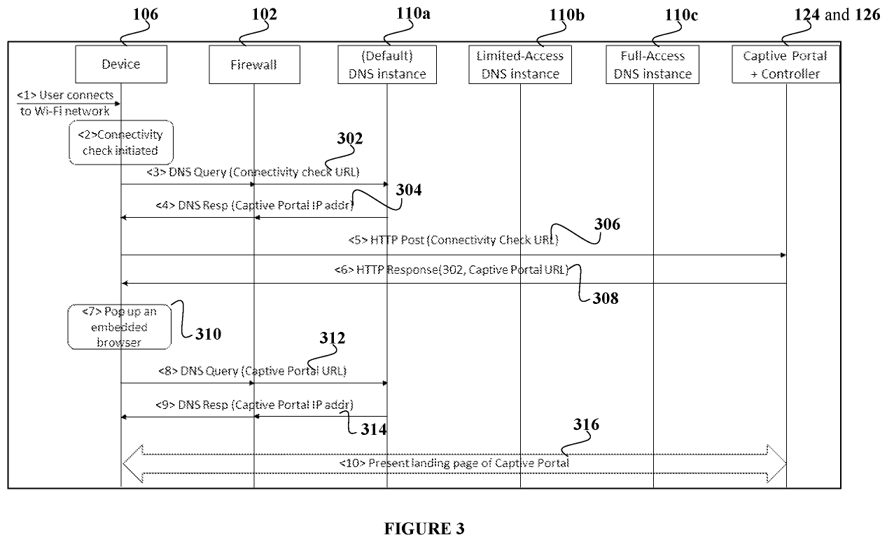

FIG. 3 is a schematic view of the workflow for unauthenticated device 106, as an embodiment of the present disclosure. As disclosed herein, the following steps are involved in the workflow for unauthenticated device 106. In a first condition of the one or more conditions, the user device 106 is connected to an available communication network, wherein the user device 106 initiates Hypertext Transfer Protocol (HTTP) requests towards the pre-defined connectivity check Uniform Resource Locators (URLs) 302. The DNS queries 116a, 116b, or 116c from user device 106 are forwarded to the Captive (Default) DNS instance 110a. The Captive (Default) DNS instance 110a resolves a website fully qualified domain name (FQDN) to a Captive Portal (CP) IP address 304, and the connectivity check HTTP requests 306 are routed to the Captive Portal 124 over an IP transport network.

The Captive Portal 124 responds with redirect indication (HTTP 302 response) and a Captive Portal URL 308. The user device 106 opens an embedded browser 310 in the user device 106 in a predefined manner. The user device 106 sends 312 a DNS query 116a, 116b, or 116c for the Captive portal FQDN, wherein the Captive (Default) DNS instance resolves and responds 314 the Captive portal FQDN to IP address of the Captive Portal 124. The user device 106 is presented with a landing page 316 of the Captive Portal 124, and the user is limited to interact with the Captive Portal 124 alone and no Internet access is allowed, as per access policy enforced by the firewall.

In other words, as shown in the drawing, Step 1: The user connects the device (smart phone) 106 to available Wi-Fi network. Step 2: The user device 106 initiates HTTP requests towards the connectivity check URLs. Step 3: DNS queries from a device reaches the Captive (Default) DNS instance. Step 4: The Captive (Default) DNS resolves the site FQDN to Captive Portal server IP address. Step 5: The connectivity check HTTP requests are routed to the Captive Portal 124 over the IP transport network. Step 6: The Captive Portal HTTP server responds with HTTP 302 response and the Captive portal URL. Step 7: User device opens the embedded browser in a device specific manner. Step 8: User Device 106 does a DNS query for the Captive portal FQDN. Step 9: The Captive (Default) DNS resolves the Captive portal FQDN as per the configured rules. Step 10: User is presented with the landing page of Captive Portal 124. Further, the user can only interact with Captive portal 124 only and no Internet access is allowed (per the access permissions enforced by firewall).

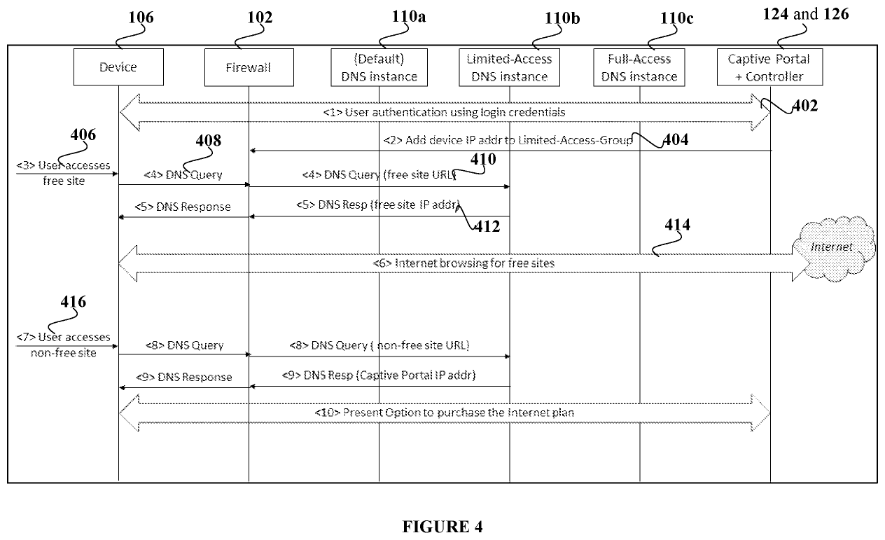

FIG. 4 is a schematic view of the workflow for devices in limited-access tier, as an embodiment of the present disclosure. As disclosed herein, the following steps are involved in the workflow for devices in limited-access tier. In a second condition of the one or more conditions, the user device 106 is authenticated by providing a login credential 402 at the Captive Portal 124 login page. The Captive Network Controller (CNC) 126 associates the user device 106 with a Limited-Access-Group policy 404 at the firewall 102 by using a firewall management API. When the user opens a browser and tries to access a free website 406, the associated DNS query 116a, 116b, or 116c reaches 408 the firewall 102. Here, the authorization process is an independent procedure than the actual internet surfing. The DNS query 116a, 116b, or 116c is forwarded 410 to a Limited-Access DNS instance 110b. The Limited-Access DNS instance 110b resolves free website FQDN to correct IP address 412, and wherein HTTP traffic is routed to a correct website and the user device is enabled to interact with free website 414. The user opens a browser 416 and tries to access a non-free website and the DNS query 116a, 116b, or 116c reaches the Limited-Access DNS instance 110b, wherein the Limited-Access DNS instance 110b resolves the non-free website FQDN to the Captive Portal IP address, and the user device 106 is redirected to the Captive Portal 124 and presented with the option to purchase an Internet plan.

In other words, Step 1: User authenticates himself/herself by providing the login credential at the Captive Portal 124. Step 2: Captive Network Controller 126 associates the user device 106 with the Limited-Access-Group policy at the firewall 102 by using the firewall management API. Step 3: User opens a browser and tries to access a free site. Step 4: DNS query reaches the firewall 102, where it gets forwarded to the Limited-Access DNS instance 110b. Step 5: The Limited-Access DNS instance 110b resolves free site FQDN to correct IP address. Step 6: HTTP traffic is routed to the correct site and user can interact with the white-listed sites (for e.g., partner sites for reservations, airlines sites for flight status, etc.). Step 7: User opens a browser and tries to access a non-free site. Step 8: DNS query reaches the Limited-Access DNS instance 110b. Step 9: The Limited-Access DNS 110b resolves the non-free site FQDN to the Captive Portal IP address. Step 10: User is redirected to the Captive Portal 124 and presented with the option to purchase Internet plan.

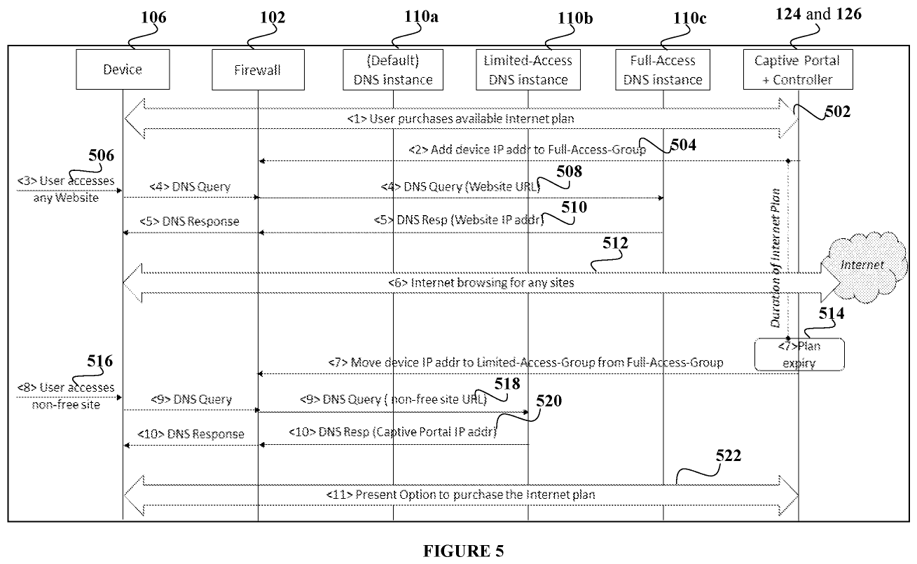

FIG. 5 is a schematic view of the workflow for devices in full-access tier, as an embodiment of the present disclosure. As disclosed herein, the following steps are involved in the workflow for devices in full-access tier. In a third condition of the one or more conditions, the user purchases 502 an internet plan by following an appropriate workflow of the Captive Portal 124 and the CNC 126 associates the user device 106 with a Full-Access-Group policy 504 at the firewall 102 by using the firewall management API. The user then tries to access 506 any website on the Internet from a browser, where a DNS query 116a, 116b, or 116c reaches the firewall 102. The DNS query 116a, 116b, or 116c is forwarded to a Full-Access DNS instance 508, where the Full-Access DNS instance resolves the website FQDN to correct IP address. The HTTP traffic from the user device 106 is routed 510 to a correct website and user is enabled to interact 512 with the website. When the Internet plan expires 514, the user device 106 is disassociated from the Full-Access-Group policy and associated with a Limited-Access-Group policy. The user opens the browser and tries to access a non-free website 516 and a DNS query 116a, 116b, or 116c reaches a Limited-Access DNS instance 518. Here, the Limited-Access DNS instance resolves the non-free website FQDN to the Captive Portal IP address, and the user device is redirected 520 to the Captive Portal and presented with the option to purchase 522 the Internet plan.

In other words, step 1: User purchases the Internet plan by following the appropriate workflow of the Captive Portal 124. Step 2: Captive Network Controller 126 associates the user device 106 with the Full-Access-Group policy 110c at the firewall 102 by using the firewall management API. Step 3: The user opens a browser and tries to access a website on Internet. Step 4: DNS request reaches the firewall 102, where it gets forwarded to the Full-Access DNS instance 110c. Step 5: The Full-Access DNS instance resolves the website FQDN to correct IP address. Step 6: HTTP traffic from the user device 106 is routed to correct site and user is enabled to interact with the website. Step 7: When the Internet plan expires, the user device 106 is disassociated from the from the Full-Access-Group policy 110c and associated with the Limited-Access-Group policy 110b. Step 8: User opens a browser and tries to access a non-free site. Step 9: DNS query reaches the Limited-Access DNS instance. Step 10: The Limited-Access DNS resolves the non-free site FQDN to the Captive Portal IP address. Step 11: User is redirected to the Captive Portal 124 and presented with the option to purchase Internet plan.

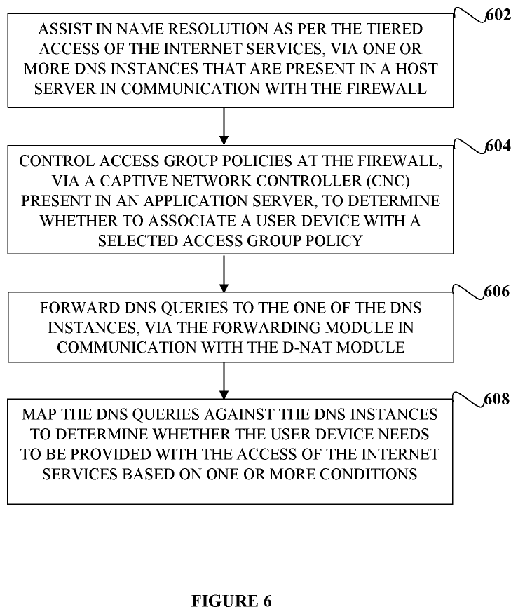

FIG. 6 is a schematic view of the method associated with the policy-based DNS resolution, as an embodiment of the present disclosure. In other words, FIG. 6 describes and illustrates a method for conditional forwarding to Domain Name Server (DNS) instance in a captive portal for tiered access of internet services, the method comprising, a first step 602 of assisting in name resolution as per the tiered access of the internet services, via one or more DNS instances that are present in a host server in communication with a firewall. A second step of controlling 604 access group policies at the firewall, via a captive network controller (CNC) present in an application server, to determine whether to associate a user device with a selected access group policy. A third step of forwarding 606 DNS queries to the one of the DNS instances, via the forwarding module in communication with the D-NAT module. Finally, a fourth step of mapping 608 the DNS queries against the DNS instances to determine whether the user device needs to be provided with the access of the internet services based on one or more conditions.

As will be appreciated by one of skill in the art, the present invention may be embodied as a method, system and apparatus. Accordingly, the present invention may take the form of an entirely hardware embodiment, a software embodiment or an embodiment combining software and hardware aspects.

It will be understood that each block of the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the drawings and specification, there have been disclosed exemplary embodiments of the invention. Although specific terms are employed, they are used in a generic and descriptive sense only and not for purposes of limitation of the scope of the invention.

We claim:

1. A system for conditional forwarding to Domain Name Server (DNS) instance in a captive portal for tiered access of internet services, the system comprising:
at least one processor that operates under control of a stored program comprising a sequence of program instructions to control one or more components, wherein the components comprising:
a firewall that comprises an access policy module, a forwarding module, and a Destination Network Address Translation (D-NAT) module;
a host server in communication with the firewall, wherein the host server comprises one or more DNS instances that assist in name resolution as per the tiered access of the internet services;
an application server in communication with the firewall, wherein the application server comprises of the captive portal (CP) and a captive network controller (CNC), wherein the CNC controls the access group policies at the firewall to determine whether to associate a user device with a selected access group policy,
the access policy module contains data comprising the access group policies associated with one or more user devices; and
the forwarding module in communication with the D-NAT module forwards DNS queries to the one of the DNS instances, wherein the DNS queries are mapped against the DNS instances, to determine whether the user device needs to be provided with the access of the internet services based on one or more conditions.

2. The system as claimed in claim 1, wherein the DNS instance is designated as a resolver for an access group.

3. The system as claimed in claim 1, wherein the forwarding of the DNS queries is based on the access group policies at the firewall, wherein separate sub-interfaces are used corresponding to each of the DNS instances, and wherein an IP addresses assigned to the DNS instances are from different logical subnets.

4. The system as claimed in claim 1, wherein the user device is provided with the tiered access of the internet services by associating or disassociating the user device with the access group policy and based on the conditions that include whether the user device is one of unauthenticated, authenticated, and in an active plan.

5. The system as claimed in claim 1, wherein in a first condition of the one or more conditions, the user device is connected to an available communication network, wherein the user device initiates Hypertext Transfer Protocol (HTTP) requests towards the pre-defined connectivity check Uniform Resource Locators (URLs), and wherein the DNS queries from user device are forwarded to the Captive (Default) DNS instance.

6. The system as claimed in claim 5, wherein the Captive (Default) DNS instance resolves a website fully qualified domain name (FQDN) to a Captive Portal (CP) IP address, wherein connectivity check HTTP requests are routed to the captive portal over an IP transport network, wherein the captive portal responds with redirect indication (HTTP 302 response) and a captive portal URL, and wherein the user opens an embedded browser in the user device in a predefined manner.

7. The system as claimed in claim 6, wherein the user devices sends a DNS query for the captive portal FQDN, wherein the captive DNS instance, which is default, resolves the captive portal FQDN to IP address of the captive portal, wherein the user device is presented with a landing page of the captive portal, and wherein the user is limited to interact with the captive portal and no internet access is allowed, as per access policy enforced by the firewall.

8. The system as claimed in claim 1, wherein in a second condition of the one or more conditions, the user device is authenticated by providing a login credential at the captive portal login page, wherein the captive network controller (CNC) associates the user device with a limited-access-group policy at the firewall by using a firewall management API.

9. The system as claimed in claim 8, wherein the user tries to access a free website from a browser, wherein the associated DNS query reaches the firewall, where the DNS query is forwarded to a limited-access DNS instance, wherein the limited-access DNS instance resolves free website FQDN to correct IP address, and wherein HTTP traffic is routed to a correct website and the user device is enabled to interact with free website.

10. The system as claimed in claim 9, wherein the user opens a browser and tries to access a non-free website and the DNS query reaches the limited-access DNS instance, wherein the limited-access DNS instance resolves the non-free website FQDN to the captive portal IP address, and the user device is redirected to the captive portal and presented with the option to purchase an internet plan.

11. The system as claimed in claim 1, wherein in a third condition of the one or more conditions, the user purchases an internet plan by following an appropriate workflow of the captive portal, wherein the CNC associates the user device with a full-access-group policy at the firewall by using the firewall management API.

12. The system as claimed in claim 11, wherein the user tries to access any website on the internet from a browser, wherein a DNS query reaches the firewall, where the DNS query is forwarded to a full-access DNS instance, wherein the full-access DNS instance resolves the website FQDN to correct IP address, wherein HTTP traffic from the user device is routed to a correct website and user is enabled to interact with the website, and wherein when internet plan expires, the user device is disassociated from the full-access-group policy and associated with a limited-access-group policy.

13. The system as claimed in claim 12, wherein the user opens the browser and tries to access a non-free website, wherein a DNS query reaches a limited-access DNS instance, wherein the limited-access DNS instance resolves the non-free website FQDN to the Captive Portal IP address, and the user device is redirected to the captive portal and presented with the option to purchase the internet plan.

14. A method for conditional forwarding to Domain Name Server (DNS) instance in a captive portal for tiered access of internet services, the method comprising:
providing at least one processor that operates under control of a stored program comprising a sequence of program instructions to control one or more components, wherein the components comprising a firewall that comprises an access policy module containing data comprising access group policies associated with one or more user devices, a forwarding module, and a Destination Network Address Translation (D-NAT) module, wherein the program instructions comprising;
assisting in name resolution as per the tiered access of the internet services, via one or more DNS instances that are present in a host server in communication with the firewall;
controlling access group policies at the firewall, via a captive network controller (CNC) present in an application server, to determine whether to associate a user device with a selected access group policy;
forwarding DNS queries to the one of the DNS instances, via the forwarding module in communication with the D-NAT module; and
mapping the DNS queries against the DNS instances to determine whether the user device needs to be provided with the access of the internet services based on one or more conditions.

15. The method as claimed in claim 14, wherein the forwarding of the DNS queries is based on the access group policies at the firewall, wherein separate sub-interfaces are used corresponding to each of the DNS instances, and wherein an IP addresses assigned to the DNS instances are from different logical subnets.

16. The method as claimed in claim 1, further comprising one of associating and disassociating the user device with the access group policy based on the conditions that include whether the user device is one of unauthenticated, authenticated, and in an active plan, so that the user device is provided with the tired access of internet services.

17. The method as claimed in claim 14, wherein in a first condition of the one or more conditions:
connecting the user device to an available communication network;
initiating hypertext transfer protocol (HTTP) requests from the user device towards the pre-defined connectivity check uniform resource locators (URLs), and
forwarding the DNS queries from user device to the captive DNS instance, which is the default.

18. The method as claimed in claim 17, further comprising:
resolving a website fully qualified domain name (FQDN) to a Captive Portal (CP) IP address via the Captive DNS instance;
routing connectivity check HTTP requests to the captive portal over an IP transport network, wherein the captive portal responds with redirect indication (HTTP 302 response) and a captive portal URL; and
opening an embedded browser in the user device in a predefined manner.

19. The method as claimed in claim 18, further comprising:
sending a DNS query, via the user device, for the captive portal FQDN, wherein the captive DNS instance is default, to resolve the captive portal FQDN to IP address of the captive portal; and
presenting the user device with a landing page of the captive portal, and
limiting interaction of the user with the captive portal and no internet access is allowed, as per access policy enforced by the firewall.

20. The method as claimed in claim 14, wherein in a second condition of the one or more conditions:
authenticating the user device by providing a login credential at the captive portal login page; and
associating, via the CNC, the user device with a limited-access-group policy at the firewall by using a firewall management API.

21. The method as claimed in claim 20, further comprising:
accessing a free website from a browser via the user, wherein the associated DNS query reaches the firewall;
forwarding the DNS query to a limited-access DNS instance, wherein the limited-access DNS instance resolves free website FQDN to correct IP address; and
routing the HTTP traffic to a correct website and enabling the user device to interact with free website.

22. The method as claimed in claim 21, further comprising:
opening a browser by the user and the user accessing a non-free website and the DNS query reaches the limited-access DNS instance;
resolving the non-free website FQDN, via the limited-access DNS instance, to the captive portal IP address; and
redirecting the user device to the captive portal and presenting the user with the option to purchase an internet plan.

23. The method as claimed in claim 14, wherein in a third condition of the one or more conditions:
purchasing an internet plan by the user by following an appropriate workflow of the captive portal; and
associating the user device with a full-access-group policy, via the CNC, at the firewall by using the firewall management API.

24. The method as claimed in claim 23, further comprising:
accessing any website by the user on the internet from a browser, wherein a DNS query reaches the firewall, where the DNS query is forwarded to a full-access DNS instance;
resolving the website FQDN via the full-access DNS instance to correct IP address, wherein HTTP traffic from the user device is routed to a correct website and the user is enabled to interact with the website; and
disassociating the user device from the full-access-group policy and associating with a limited-access-group policy, when internet plan expires.

25. The method as claimed in claim 24, further comprising:
opening the browser and accessing a non-free website by the user, wherein a DNS query reaches a limited-access DNS instance;
resolving the non-free website FQDN using the limited-access DNS instance to the captive portal IP address; and
redirecting the user device to the captive portal and presented with the option to purchase the internet plan.

26. A computer program product for conditional forwarding to Domain Name Server (DNS) instance in a captive portal for tiered access of internet services, comprising a processor and memory storing instructions thereon, wherein the instructions when executed by the processor causes the processor to:
assist in name resolution as per the tiered access of the internet services, via one or more DNS instances that are present in a host server in communication with a firewall;
control access group policies at the firewall, via a captive network controller (CNC) present in an application server;
determine whether to associate a user device with a selected access group policy;
forward DNS queries to the one of the DNS instances, via the forwarding module in communication with the D-NAT module; and
map the DNS queries against the DNS instances to determine whether the user device needs to be provided with the access of the internet services based on one or more conditions.
